(19) United States
(12) Patent Application Publication
(10) Pub. No.: US 2026/0352385 A1
(43) Pub. Date: Nov. 5, 2026

(54) NEGOTIATED HYBRID LINK TRAINING FOR ENHANCED DATA TRANSMISSION RELIABILITY

(71) Applicant: NVIDIA Corporation, Santa Clara, CA (US)

(72) Inventors: Leon Bruckman, Petah Tikva (IL); Stas Gurtovoy, Nesher (IL); Gil Golan, Netanya (IL); Guy Lederman, Ness Ziona (IL); Assaf Haiman, Kfar Hes (IL); Jiaxiang Liu, San Jose, CA (US); Lavi Koch, Jerusalem (IL); Ran Ravid, Tel Aviv (IL)

(21) Appl. No.: 19/195,046

(22) Filed: Apr. 30, 2025

(51) Int. Cl. H04L 1/24; H04L 1/00; H04L 1/20

(52) U.S. Cl. CPC H04L 1/244; H04L 1/0001; H04L 1/203

(57) ABSTRACT

A first device includes an interface to couple to a physical link. The first device transmits, during a first time period of a link training (LT) operation, a first message to a second device connected to the first device via the interface. The first message includes an indication of a second time period of the LT operation during which an uninterrupted training pattern is to be transmitted. The first device transmits, during the second time period of the LT operation, a second message to the second device via the interface. The second message includes the uninterrupted training pattern used to perform training to achieve a first minimum bit error ratio (BER) performance for transmissions from the first device to the second device.

### TECHNICAL FIELD

At least one embodiment pertains to link training of a physical communication link between two devices.

### BACKGROUND

In many communication systems, such as those used in SerDes-based architectures, link training is an initialization process that occurs before normal data transmission begins. The purpose of link training is to optimize signal integrity and establish reliable communication between a transmitter and a receiver across a physical link. During this process, both ends of the link iteratively adjust parameters—such as equalization settings, output swing, and pre-emphasis—to compensate for channel impairments like insertion loss, crosstalk, and jitter. Link training is typically conducted using a standardized training frame or training sequence, which includes a header and a known symbol pattern or bit pattern.

### BRIEF DESCRIPTION OF THE DRAWINGS

FIG. 1 illustrates a network with peer devices coupled by a physical link, according to one embodiment.

FIG. 2 illustrates a timing diagram showing alternating time periods T1 and T2 of the hybrid LT process performed by the hybrid LT logic, according to one embodiment.

FIG. 3A and FIG. 3B illustrate a timing diagram of the hybrid LT process, according to one embodiment.

FIG. 4 is a flowchart illustrating a method of performing a hybrid LT process, according to one embodiment.

FIG. 5A illustrates an example communication system with devices that includes hybrid LT logic, in accordance with at least some embodiments.

FIG. 5B illustrates a block diagram of an example communication system that includes hybrid LT logic, according to at least one embodiment.

FIG. 6 illustrates an example computer system including a spectrum hardware engine and an error correction block according to at least one embodiment.

FIG. 7 is a block diagram of a computing system having two processing devices coupled to each other and multiple networks according to at least one embodiment.

FIG. 8 is a block diagram of a computing system having a central processing unit (CPU) and a graphics processing unit (GPU) in a single integrated circuit according to at least one embodiment.

FIG. 9 is a block diagram of a computing system having tensor core graphics processing units (GPUs) according to at least one embodiment.

### DETAILED DESCRIPTION

Conventional link training (LT) techniques are, in many ways, inefficient or inadequate at achieving low Bit Error Ratio (BER) performance. Standard LT frames are designed to include a header and a training pattern just long enough to calculate a minimum BER required by the standard (e.g., 1E-5). In many cases, users expect better performance than this minimum BER. However, the size of standard LT frames does not conventionally allow for a longer, uninterrupted training pattern that could be used to measure a BER better than the minimum BER (e.g., 1E-8).

One approach to address the inadequacy of current LT approaches is to simply ignore the problem. This means accepting the minimum Bit Error Ratio (BER) performance defined by the standard (e.g., 1E-5). While this approach might be easier to implement, it results in suboptimal BER performance. Users typically expect much lower BER for reliable performance, especially in high-rate transmissions over copper and potentially optical links. Ignoring the problem means that the interruptions caused by the LT frame header would continue to introduce errors in the Pseudo-Random Binary Sequence (PRBS), hindering accurate BER estimation and making it challenging to achieve better performance.

Another possible solution may involve masking the BER counter during the LT frame header to avoid errors. This approach would typically require a signal to mask the BER counter, which is not supported by at least some existing devices. This is because these existing devices were deployed in the field under an assumption that a single frame payload would be enough to optimize performance. As such, this solution would be impractical for deployment with respect to at least these existing devices.

Aspects and embodiments of the present disclosure address the above-described challenges and others by providing a hybrid LT process that allows for longer uninterrupted training periods. In other words, the hybrid LT process can include a first period of time T1 dedicated to transmission of a training signal without interruption. The hybrid LT process can involve allowing a side of a link to request a second side of the link to stop standard LT header transmission for the first period of time T1 and transmit standard LT frames for a second period of time T2 cyclically. The first period of time T1 may be longer than a typical time interval required to transmit a standard LT frame. Aspects and embodiments of the present disclosure can allow for continuous transmission of the training signal (e.g., PRBS) during T1 without interruptions (i.e., without intermittent frame headers), thereby improving BER estimation and achieving better performance.

The hybrid LT process can involve negotiating the period T1 to synchronize LT header transmission from both sides. In some cases, the length of the period T1 may be preconfigured and not negotiated. The second time period T2, where standard LT frames are transmitted between sides of the physical link (i.e., devices communicatively coupled by the physical link), may also be negotiated. These standard LT frames may be defined by IEEE 802.2-2022 Clause 136. In at least some embodiments, reserved bits within the header of the standard LT frame may be used

In some embodiments, standard LT frames are transmitted continuously during T2, while during T1, only training patterns are transmitted between the sides of the physical link. If the standard LT frames are defined by IEEE 802.3-2022 Clause 136, the reserved training pattern request and status bits in the control and status fields of the standard LT frame architecture may be used to request and acknowledge the hybrid LT mode. The PRBS to be transmitted can be negotiated using the standard protocol before starting the hybrid LT mode negotiation phase. Each side of the physical link can propose a length for T1, and the longest proposed length may be selected. The largest proposed length for T1 may be used because, in at least some cases, LT is a bidirectional process in which both sides of the physical link concurrently act as both the signaling and remote sides, and selecting the larger proposed T1 ensures that both sides have sufficient time to compute the BER according to their respective configurations. The negotiated length (often represented by a value) of T1 may be carried in specific bits of the control and status fields of the LT header. If the standard LT frames are defined by IEEE 802.3-2022 Clause 136, the proposed length(s) of T1 may be carried by control field bits 4:0 and 13:11, and the negotiated length of T1 may be carried by status field bits 5:0, 6, and 14. In some cases, the proposed length(s) of T1 may be carried by a different set of control field bits, and/or the negotiated length of T1 may be carried by a different set of status field bits. When both sides are ready, a training pattern only (or training signal only) phase starts and lasts for the negotiated T1. In at least one direction, only the training pattern is transmitted across the physical link during this phase. Once the training pattern only phase is completed (i.e., when T1 expires), the standard LT protocol may be resumed during T2.

In an exemplary flow of the hybrid LT process, initially, a first side of a link may request that a second side of the link perform the hybrid LT process. This may involve configuring one or more bits of an LT header (e.g., reserved bits 6:5 of control field=10) transmitted from the first side to the second side. If the second side supports the hybrid LT process, the second side may configure one or more bits of an LT header (e.g., reserved bits 13:12 of status field=10) to acknowledge the request to perform the hybrid LT process.

Then, after the sides agree to perform the hybrid LT process, the sides may negotiate the first period of time (T1) that an uninterrupted training pattern is transmitted between the sides. This may also be referred to as a training pattern only phase, or an uninterrupted training pattern phase. During negotiation, the sides may each propose a value for T1 (or for a number of N-bit blocks). The larger of the proposed values may be selected for T1.

After the value of T1 is selected and both the signaling and remote sides are ready, the uninterrupted training pattern phase starts and lasts for the negotiated T1. During this phase, only the training signal is transmitted, allowing for a long period of uninterrupted training pattern transmission. This can significantly improve BER estimation and, consequently, overall link performance. After the T1 period, the standard LT frames may again be transmitted continuously during a different time period (T2). The standard LT frames may be transmitted using standard LT protocol.

The hybrid LT process may allow for several iterations of T1 and T2. For example, the hybrid LT process can allow for a training pattern only phase each time that one or more parameters of the sides or the physical link are adjusted to improve signal quality. After both the sides are satisfied with the signal quality (i.e., BER), they can stop the hybrid LT process and move either to data mode or to a standard LT protocol. The receiver ready bit in the control and status fields can be used to indicate that hybrid training is completed. When one of the sides finishes the hybrid training, the other side may stop transmitting the training signal during T1 and may transmit other frames during T1, such as LT frames or pause frames.

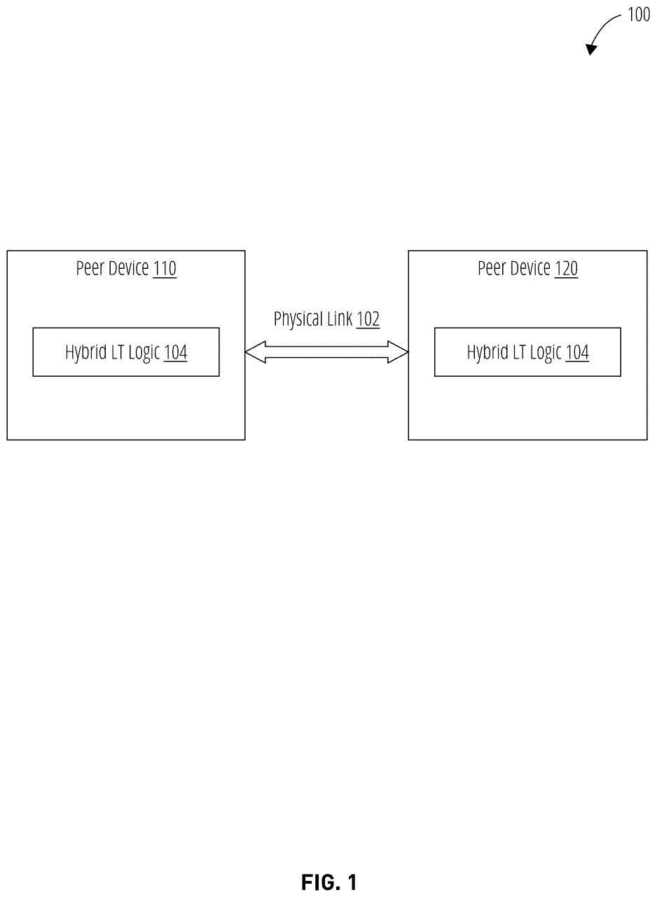

FIG. 1 illustrates a network 100 with a peer device 110 and a peer device 120 with hybrid LT logic 104, according to one embodiment. The peer device 110 and peer device 120 may be communicatively coupled together via a physical link 102. In one embodiment, the physical link 102 may be a serializer/deserializer (SerDes) link 102. In some embodiments, the physical link 102 may be an optical link. The physical link 102 may be an Ethernet® connection. The physical link 102 may be any other suitable physical link between two peer devices 110, 120. The physical link 102 may serve as the medium through which the two peer devices communicate, enabling the exchange of data and control signals. According to embodiments, the peer device 110 and peer device 120 may communicate over the physical link 102 using SerDes techniques and technologies. In at least some embodiments, the peer device 110 and peer device 120 may each include an interface that is configured to be coupled to the physical link 102.

According to embodiments, the hybrid LT logic 104 may perform a hybrid link training (LT) process. The hybrid LT logic 104 may include software, firmware, hardware, or any combination thereof. In some embodiments, the hybrid LT logic 104 may include different operations performed by each side of the physical link 102 (i.e., the peer device 110 and the peer device 120) depending on their particular role (e.g., signaling side, remote side). The hybrid LT process performed by the hybrid LT logic 104 may address inefficiencies and inadequacies of conventional LT techniques in achieving low Bit Error Ratio (BER) performance. The hybrid LT process performed at least partially by the hybrid LT logic 104 allows for longer uninterrupted training periods, which improves BER estimation. This hybrid LT process may be cyclic and include of two alternating time periods: T1 and T2. During T1, the hybrid LT logic 104 may transmit a training pattern (sometimes referred to as a training signal) continuously without interruptions (i.e., no LT headers) over a longer period of time than designed for within standard LT frames, allowing for a more accurate BER estimation. In general, a longer training pattern improves bit error rate (BER) estimation by providing a larger sample size of known bits, enabling more accurate detection of transmission errors and reducing statistical variance in the BER calculation. During T2, the hybrid LT logic 104 transmits standard LT frames continuously, which include a header and a training pattern.

The hybrid LT process may begin with the hybrid LT logic 104 initiating the process by requesting the second side (peer device 120) to perform the hybrid LT process. This request may be made by configuring specific bits in the LT header (e.g., reserved bits 6:5 of the control field set to 10) transmitted from the first side (peer device 110) to the second side. In other embodiments, the request may be made through various suitable signaling techniques not limited to configuring specific control field bits in the LT header. If the second side supports the hybrid LT process, the hybrid LT logic 104 on the second side can acknowledge the request by configuring specific bits in the LT header (e.g., reserved bits 13:12 of the status field set to 10). In other embodiments, the acknowledgement of the request may be made through various suitable signaling techniques not limited to configuring specific status field bits in the LT header.

Following this acknowledgment, the hybrid LT logic 104 can negotiate the length of T1. Each side of the physical link 102 can propose a value for T1 (or for a number of N-bit blocks), and the larger of the proposed values is selected. Selecting the larger proposed T1 can help ensure that both sides of the physical link 102 have sufficient time to compute the BER according to their respective configurations (which may be different). For example, if the peer device 110 is configured to have a target minimum BER of 1E-10, and the peer device 120 is configured to have a target minimum BER of 1E-12, the peer device 120 may propose a longer T1 than the peer device 110. In at least one embodiment, one side may have a slower processor or less efficient process to compute BER, and therefore may propose a larger proposed T1. The proposed value of T1 may be carried in control field bits 4:0 and 13:11, while the negotiated value of T1 is carried in status field bits 5:0, 6, and 14. However, in other embodiments, the proposed and negotiated values for T1 may be made through various suitable signaling techniques not limited to configuring specific control field bits or status field bits of the LT header. Additionally, the negotiation of T1 can involve different types of values, such as time intervals, block counts, or other relevant metrics to T1. Notwithstanding the above, in at least some embodiments, the duration of T1 may be preconfigured and may not be negotiated.

Once the length of T1 is selected and both sides are ready, the hybrid LT logic 104 starts the uninterrupted training pattern phase, which lasts for the negotiated T1. During this phase, only the training signal is transmitted between the sides, allowing for a long period of uninterrupted training pattern transmission. During the uninterrupted training pattern phase, the hybrid LT logic 104 can transmit different types of training patterns, including but not limited to Pseudo-Random Binary Sequence (PRBS). This phase can significantly improve BER estimation beyond a standard or default minimum BER (e.g., 1E-5) and, consequently, overall link performance. After T1 expires, the uninterrupted training pattern phase ends, and the hybrid LT logic 104 may transmit standard LT frames continuously during T2. The standard LT frames may be transmitted using the standard LT protocol. In other embodiments, the transmission of standard LT frames during T2 can follow various protocols and standards according to configurations of the peer device 110 and/or peer device 120. In at least some cases, the duration of T2 may be negotiated between the sides of the physical link 102 in a manner similar to how the duration of T1 is negotiated. In other embodiments, T2 may be pre-configured or may vary between iterations of T1.

The length of the uninterrupted training pattern transmitted during T1 can be determined based on the negotiated length of T1. Once both sides of the physical link 102 decide on T1, the length of the uninterrupted training pattern can be selected based on T1's length. The length of the uninterrupted training pattern may be selected so that it is continuously transmitted throughout the duration of T1.

The hybrid LT logic 104 may allow for several iterations of T1 and T2. For example, the hybrid LT process can implement an uninterrupted training pattern phase each time that one or more parameters of the sides or the physical link are adjusted to improve signal quality. These parameters may include, but are not limited to, transmitter pre-emphasis levels, transmitter output swing, receiver Continuous-Time Linear Equalizer (CTLE) settings, decision feedback equalizer (DFE) tap weights, feed-forward equalizer (FFE) tap coefficients, clock and data recovery (CDR) bandwidth, termination impedance, lane polarity, training pattern length, symbol timing adjustments, adaptive voltage thresholds, express equalizer tap settings (including pre-cursor, main, and post-cursor taps), lane skew alignment, or the like. An uninterrupted training pattern phase may be implemented each time that one of these parameters is adjusted in order to measure signal quality corresponding to the newest configuration of the parameters.

After both sides of the physical link 102 are satisfied with the signal quality (i.e., BER), the hybrid LT logic 104 can stop the hybrid LT process and moves either to data mode or to a standard LT protocol. The hybrid LT logic 104 may use the receiver ready bit standard LT header to indicate that the hybrid LT process is completed or that a target minimum BER has been reached. In other embodiments, the hybrid LT logic 104 may use any suitable signaling technique to indicate that the hybrid LT process is completed.

The hybrid LT process can involve concurrent training of both sides of the physical link 102. In other words, the hybrid LT process can involve improving signal quality of transmission from the peer device 110 to the peer device 120, and signal quality transmission from the peer device 120 to the peer device 110. Here, both peer device 110 and peer device 120 concurrently act as the signaling side and the remote side. This means that each side is concurrently transmitting and receiving either standard LT frames during T2 or uninterrupted training patterns during T1. However, in some cases, LT for one of the transmission directions (i.e., either transmissions from peer device 110 to peer device 120 or transmissions from peer device 120 to peer device 110) may complete before the other. Here, one of the sides may be ready to transition to the next phase (data mode or standard LT) while the other side may not yet be ready to transition. Here, data other than the uninterrupted training pattern may be transmitted in the direction that has completed the hybrid LT process during T1. This data may include standard LT frames, pause frames, or other types of frames. This behavior is applicable when transmissions from one side to the other have completed the training process, but transmissions in the opposite direction are still undergoing training.

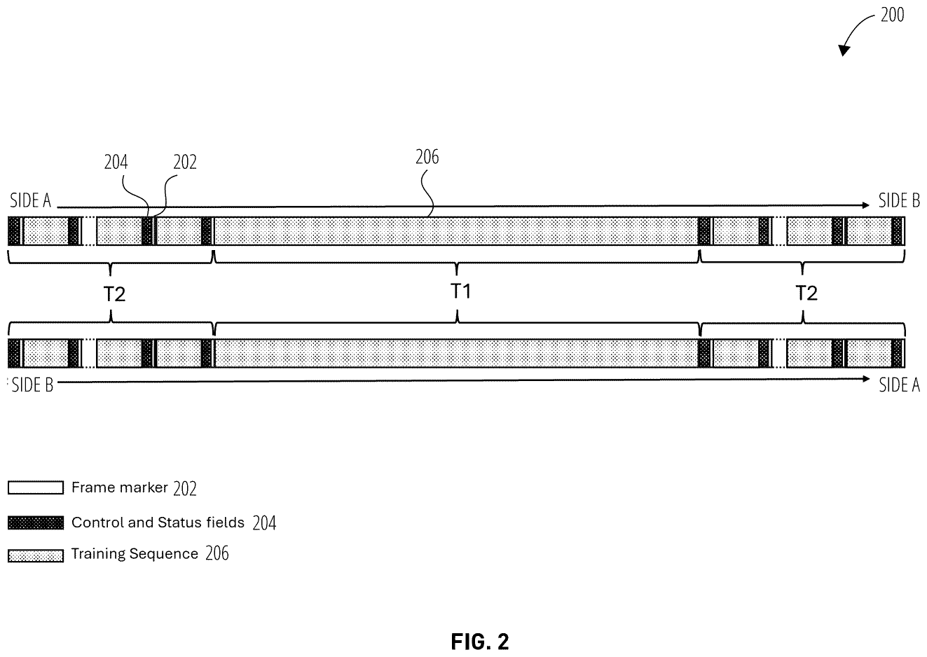

FIG. 2 illustrates a timing diagram 200 showing alternating time periods T1 and T2 of the hybrid LT process performed by the hybrid LT logic 104, according to one embodiment. The timing diagram 200 provides a visual representation of how the hybrid LT process can alternate between these two periods to improve Bit Error Ratio (BER) estimation and overall link performance.

Within T2, the timing diagram 200 includes frame markers 202, which delineate the boundaries between different standard LT frames (or other non-standard LT frames that include a header) transmitted over the physical link 102. These frame markers 202 help in identifying the start and end of each frame, ensuring proper synchronization between the peer devices 110 and 120 during T2. Each LT frame may also include control and status fields 204. A header of each LT frame may include at least a frame marker 202 and control and status fields 204.

During the T1 period, the hybrid LT logic 104 transmits training sequences 206, also referred to as training patterns, continuously without interruption. The training sequence 206 may be a single sequence, or may be many training sequences. In one embodiment, the training sequence 206 may be a same repeated training pattern. This repeated training pattern may be the same as the negotiated training patterns of the standard LT frames within T2. These training sequences 206 of T1 may be designed to provide a long, uninterrupted training signal that allows for more accurate BER estimation. The training sequence 206 may be any length greater than training sequences of standard LT frames. For example, the training sequence 206 may include more than 16,384 symbols (more than a standard length of a training sequence of a standard LT frame). In some embodiments, the training sequence 206 may be orders of magnitude longer than a standard length of a training sequence of a standard LT frame. In at least some embodiments, T1 may include a same number of unit intervals (UI) as the number of symbols included in the training sequence 206. In other embodiments, such as when the uninterrupted training sequence has a header (or at least a frame marker), T1 may include more UIs than the number of symbols included in the training sequence 206. By transmitting a larger sample size of known symbols, the hybrid LT logic 104 can detect transmission errors more accurately and reduce statistical variance in the BER calculation, particularly when the BER estimation is low (e.g., lower than 1E-5).

T2, on the other hand, involves the transmission of standard LT frames, which include headers (i.e., frame markers 202 and control and status fields 204) along with a training pattern. The control and status fields 204 can contain important information for managing the hybrid LT process, such as signaling requests, acknowledgments, and negotiated values for T1 and T2. The training sequences of the standard LT frames may also be used to estimate BER, but these training sequences will have constant interruptions by LT headers.

The hybrid LT process can alternate between T1 and T2 periods, allowing for several iterations to optimize signal quality. During T1, the focus is on transmitting an uninterrupted training sequence 206 in order to calculate an improved BER estimation. During T2, the hybrid LT logic 104 transmits standard LT frames with control and status fields 204 to manage the hybrid LT process and facilitate proper synchronization between the peer devices 110 and 120.

The timing diagram 200 also illustrates how the hybrid LT process can handle concurrent training of both sides of the physical link 102. In at least some embodiments, concurrent training involves synchronizing T1 and T2 for both sides of the physical link. This synchronization can be beneficial because maintaining proper synchronization between the sides of the physical link may be easier when the uninterrupted training sequences 206 are transmitted concurrently.

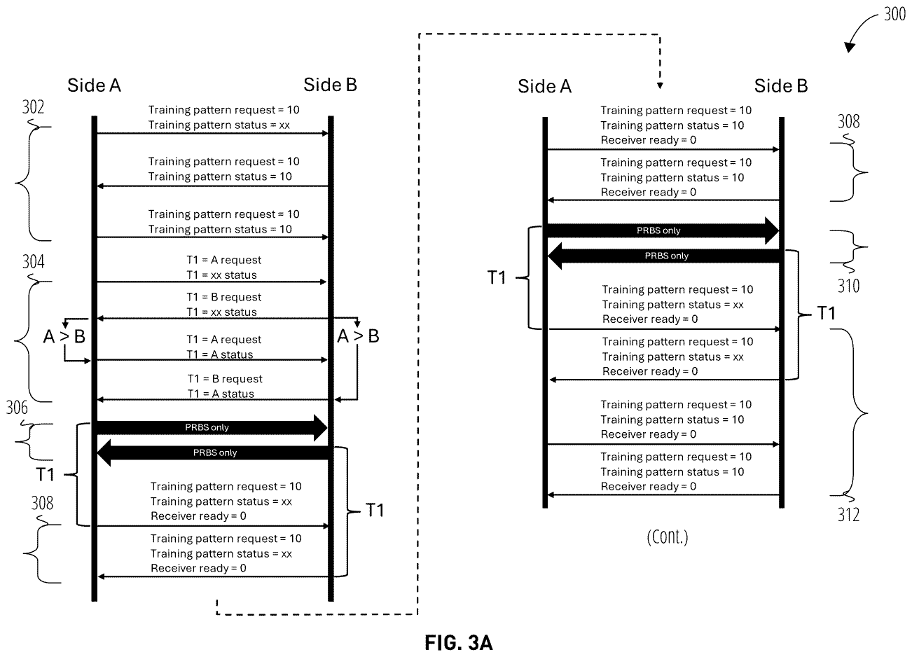

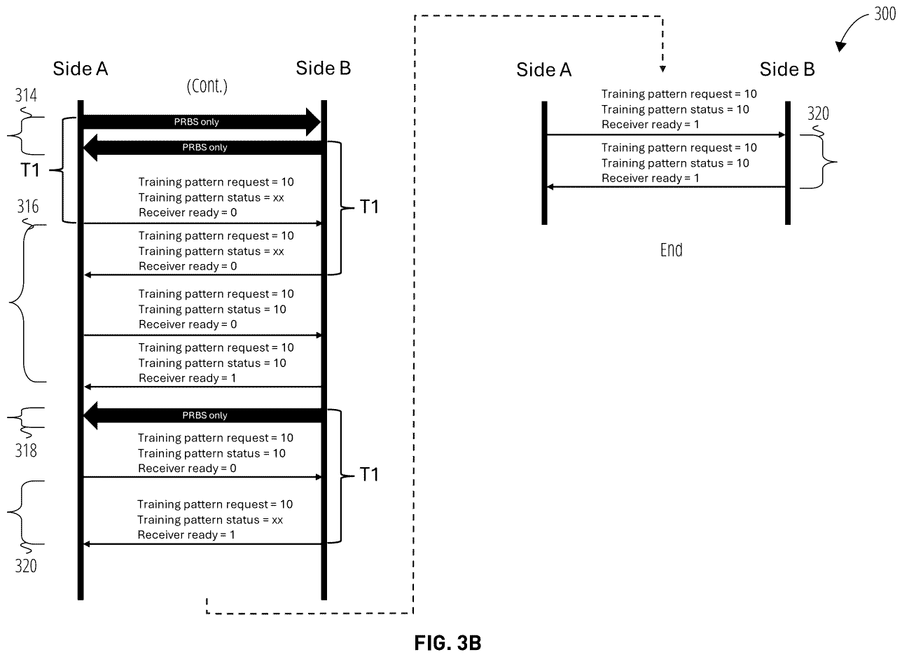

FIG. 3A and FIG. 3B illustrate a timing diagram 300 of the hybrid LT process, according to one embodiment. Some or all of the operations described in relation to the timing diagram 300 may be performed by the hybrid LT logic 104 described above with respect to FIG. 1. As illustrated, Side A may represent the peer device 110 and Side B may represent the peer device 120.

At timing block 302, the hybrid LT process may be initiated. Here, Side A may send a training pattern request to Side B. This request is made by configuring specific bits in the LT header, signaling the request to begin the training process for data transmission. Then, if Side B supports the hybrid LT process, Side B sends an acknowledgement of the request by updating its training pattern status, and sends the training pattern request back to Side A. Side A then updates its own training pattern status. After this handshake sequence is completed, both sides are ready to initialize the hybrid LT process and begin negotiation for the length of T1. T1 may be a time period for an uninterrupted training sequence, such as PRBS, as described herein.

At timing block 304, the Sides A and B negotiate the length of T1. Here, Side A and Side B may each respectively propose a length (e.g., a value) to each other. Then, the larger of the two proposed lengths is selected. As illustrated, the length proposed by side A is larger than side B, and so each of the Sides A and B set the length of T1 to the length proposed by A (e. g,. T1=A status). According to embodiments, the proposed lengths for T1 can be expressed in terms of time intervals, block counts, or other relevant metrics.

This negotiation process can help ensure that both Sides A and B agree on a suitable length for T1 that allows for uninterrupted transmission of the training sequence. The larger of the proposed values is typically selected to ensure that both sides have sufficient time to compute the BER according to their respective configurations. For example, if Side A is configured to achieve a target minimum BER of 1E-12 and Side B is configured for a target minimum BER of 1E-10, Side A may propose a longer T1 than Side B. The proposed value of T1 may be carried in specific control field bits, while the negotiated value of T1 may be carried in specific status field bits. However, the negotiation of T1 can also be achieved through various suitable signaling techniques not limited to configuring specific control and status field bits. Once the negotiation is completed and both Sides A and B agree on the length of T1, they are ready to proceed to timing block 306.

The timing block 306 may encompass the uninterrupted training pattern phase for transmission from Side A to Side B and from Side B to Side A. Here, only the training pattern is transmitted for the duration of T1. In some embodiments, the training pattern may be denoted by a frame marker or a header.

At timing block 308, at expiration of T1, standard LT frames may again be transmitted from Side A to Side B and from Side B to Side A during T2. These standard LT frames may indicate whether Sides A and B are still in hybrid LT mode (Training pattern request=10) and whether the estimated BER calculated using the observed training pattern of T1 within timing block 306 is below a BER threshold (e.g., a minimum BER threshold) (Receiver ready=0). Here, the estimated BERs for each direction of transmission may not satisfy their respective thresholds. As such, one or more parameters of either of the Sides A, B, or the physical link itself may be adjusted to improve link quality, and then each Side A, B may again indicate that they are ready to begin another iteration of the uninterrupted training pattern phase for T1 duration (Training pattern status=10).

Similar to timing block 306, the timing block 310 may encompass the uninterrupted training pattern phase for transmission from Side A to Side B and from Side B to Side A. However, this time, the parameters of Side A, Side B, the physical link, or any combination thereof may be different.

At timing block 310, at expiration of T1 within timing block 310, standard LT frames may again be transmitted from Side A to Side B and from Side B to Side A during T2, similar to timing block 308. And again, as illustrated, the estimated BERs of each direction of transmission may not satisfy their respective thresholds. As such, another round of adjusting parameters and an uninterrupted training pattern phase at timing block 314 may be implemented.

However, this time at timing block 316, the estimated BER for transmissions from Side A to Side B satisfies its respective threshold (Receiver ready=1). However, the estimated BER for transmissions from Side B to Side A may still not satisfy its respective threshold (Receiver ready=0). As such, during the next uninterrupted training pattern phase during timing block 318, the uninterrupted training pattern is transmitted from Side B to Side A for the duration of T1, but other types of frames (e.g., standard LT frames, pause frames) may be transmitted from Side A to Side B during T1.

At timing block 320, the estimated BERs for each direction of transmission may satisfy their respective thresholds (Receiver ready =1). Here, the hybrid LT process may conclude, and Sides A, B may enter a different mode, such as a standard LT mode or data mode (normal operation).

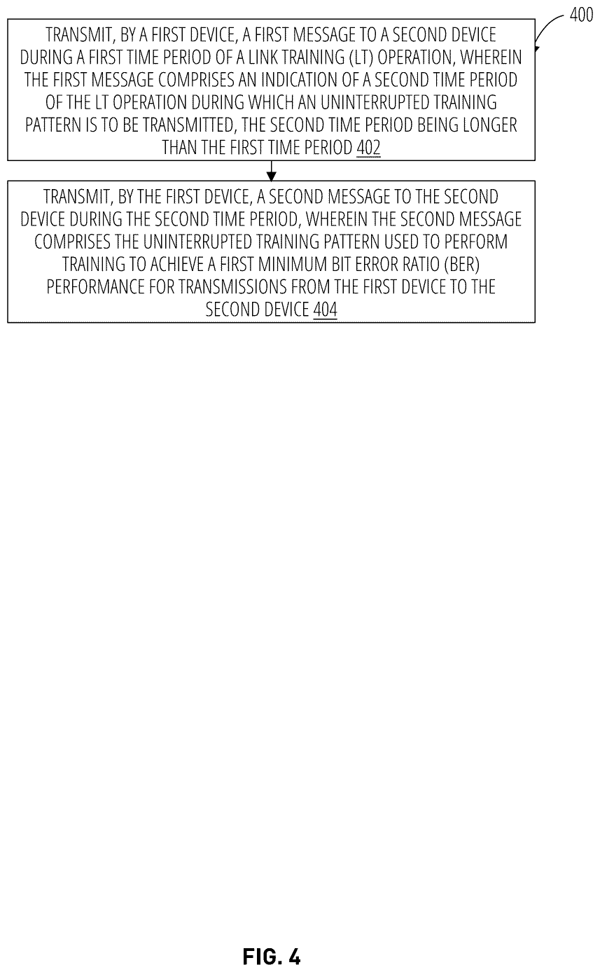

FIG. 4 is a flowchart illustrating a method 400 of performing a hybrid LT process, according to one embodiment. One or more portions of the method 400 may be performed by processing logic that includes software, firmware, hardware, or any combination thereof. The processing logic can include one or more processing units (e.g., CPUs, GPUs, accelerators, physics processing units (PPUs), data processing units (DPUs), etc.), which may include (or communicate with) one or more memory devices. The processing logic may include the hybrid LT logic 104 of FIG. 1. In at least one embodiment, processing units performing the method 400 can be executing instructions stored on a non-transient computer readable storage media. In at least one embodiment, the method 400 can be performed using multiple processing threads (e.g., CPU threads and/or GPU threads), individual threads executing one or more individual functions, routines, subroutines, or operations of the method. In at least one embodiment, processing threads implementing any of the method 400 can be synchronized (e.g., using semaphores, critical sections, and/or other thread synchronization mechanisms). Alternatively, processing threads implementing any of the method 400 can be executed asynchronously with respect to each other. Some operations of the method 400 can be performed concurrently with other operations. In at least one embodiment, one or more operations described with respect to method 400 may not always be performed.

At block 402, the processing logic may transmit, by a first device, a first message to a second device. This first message may be transmitted during a first time period (T2) of a LT operation. The first message may include an indication of a second time period (T1) of the LT operation during which an uninterrupted training pattern is to be transmitted. This second time period may be longer than the first time period.

Additionally, the first device may transmit a third message to the second device during the first time period after transmitting the first message. This third message may include a proposed duration of the second time period. The first device may also receive a fourth message during the first time period of the LT operation. This fourth message can include an indication of a third time period. This third time period may be a length of time proposed by the second device for the uninterrupted training pattern phase. In embodiments where the second time period is greater than the third time period, the second time period may be selected for the uninterrupted training pattern phase.

At block 404, the processing logic may transmit, by the first device, a second message to the second device. The second message may be transmitted during the second time period. The second message may include the uninterrupted training pattern used to perform training to achieve a first minimum bit error ratio (BER) performance for transmissions from the first device to the second device. In at least some embodiments, the second message may only include the uninterrupted training pattern. In one embodiment, the second message may not include a header.

In some embodiments, only the second message is transmitted to the second device during the second period of time. The length of the second message may be determined based on the selection of the second time period for the uninterrupted training pattern phase. The uninterrupted training pattern may include more than 16,384 symbols (e.g., more than an amount of symbols within a training pattern part of a standard LT frame). The second time period may include the same number of unit intervals (UI) as the number of symbols of the uninterrupted training pattern.

In some embodiments, LT may be performed in both directions of transmission across the physical link (i.e., from the first device to the second device, and from the second device from the first device). During the second time period of the LT operation, the first device may receive one or more third messages and perform training to achieve a second minimum BER performance for transmissions from the second device to the first device.

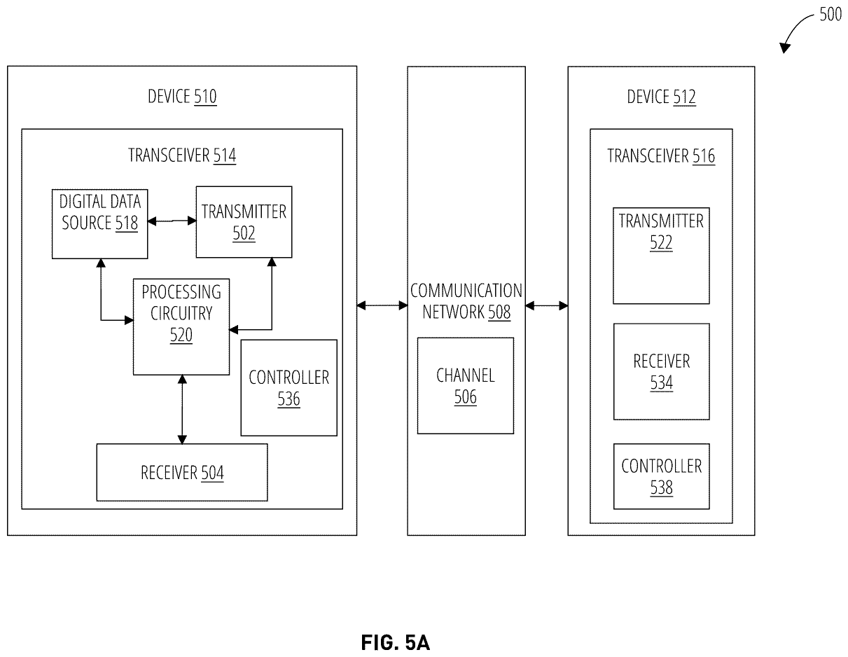

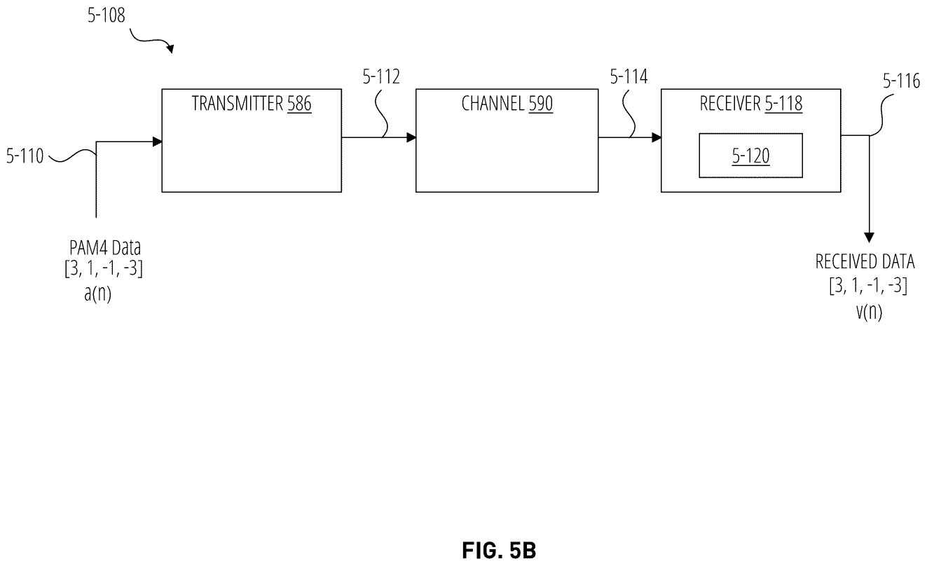

FIG. 5A illustrates an example communication system 500 with a controller 536, in accordance with at least some embodiments. The communication system 500 includes a device 510, a communication network 508 including a communication channel 506, and a device 512. In at least one embodiment, the devices 510 and 512 are integrated circuits of a Personal Computer (PC), a laptop, a tablet, a smartphone, a server, a collection of servers, or the like. In some embodiments, the devices 510 and 512 may correspond to any appropriate type of device that communicates with other devices also connected to a common type of communication network 508. In embodiments where the communication network 508 includes at least one differential pair of wires, the devices 510, 512 may each include the hybrid LT logic 104 as described herein. According to embodiments, the devices 510, 512 may each be capable of performing the method 400. According to embodiments, the transmitter 502 and 522 of devices 510 or 512 may correspond to transmitters of a Graphics Processing Unit (GPU), a switch (e.g., a high-speed network switch), a network adapter, a central processing unit (CPU), a data processing unit (DPU), etc.

Examples of the communication network 508 that may be used to connect the devices 510 and 512 include wires, conductive traces, bumps, terminals, optical fibers, or the like. In other embodiments, the communication network 508 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 508 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 508 is a network that enables data transmission between the devices 510 and 512 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller. In at least one embodiment, a system for high-speed network communication includes a processing unit, a network interface comprising a receiver or transceiver with controller or other processing device to optimize LT processes, as described herein. The processing unit can include a CPU, a GPU, a DPU, a network adapter, a network switch, an NVLink switch, or the like. Other examples for the communication network 508 can include other chip-to-chip or die-to-die interconnects, such as GRS, LPI (low power interface) or LLI (low latency interface).

The device 510 includes a transceiver 514 for sending and receiving signals, for example, data signals. The data signals may be digital or optical signals modulated with data or other suitable signals for carrying data.

The transceiver 514 may include a digital data source 518, a transmitter 502, a receiver 504, and processing circuitry 520 that controls the transceiver 514. The digital data source 518 may include suitable hardware and/or software for outputting data in a digital format (e.g., in binary code and/or thermometer code). The digital data output by the digital data source 518 may be retrieved from memory (not illustrated) or generated according to input (e.g., user input).

The transceiver 514 includes suitable software and/or hardware for receiving digital data from the digital data source 518 and outputting data signals according to the digital data for transmission over the communication network 508 to a transceiver 516 of device 512.

The receiver 504 of device 510 may include suitable hardware and/or software for receiving signals, for example, data signals from the communication network 508. For example, the receiver 504 may include components for receiving processing signals to extract the data for storing in a memory. In at least one embodiment, the transceiver 516 includes a transmitter 522 and a receiver 534. The transceiver 516 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC.

The processing circuitry 520 may comprise software, hardware, or a combination thereof. For example, the processing circuitry 520 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 520 may comprise hardware, such as an Application-Specific Integrated circuit (ASIC). Other non-limiting examples of the processing circuitry 520 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 520 may be provided on a Printed Circuit Board (PCB) or collection of PCBs. It should be appreciated that any appropriate type of electrical component or collection of electrical components may be suitable for inclusion in the processing circuitry 520. The processing circuitry 520 may send and/or receive signals to and/or from other elements of the transceiver 514 to control the overall operation of the transceiver 514.

The transceiver 514 or selected elements of the transceiver 514 may take the form of a pluggable card or controller for the device 510. For example, the transceiver 514 or selected elements of the transceiver 514 may be implemented on a network interface card (NIC).

The device 512 may include a transceiver 516 for sending and receiving signals, for example, data signals over a channel 506 of the communication network 508. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 514 may be applied to transceiver 516, and thus, the structure of transceiver 516 is not described separately.

Although not explicitly shown, it should be appreciated that devices 510 and 512 and the transceiver 514 and transceiver 516 may include other processing devices, storage devices, and/or communication interfaces generally associated with computing tasks, such as sending and receiving data.

FIG. 5B illustrates a block diagram of an example communication system 5-108 employing a receiver 5-118 with a controller 5-120, according to at least one embodiment. In the example shown in FIG. 5B, a Pulse Amplitude Modulation level-4 (PAM4) modulation scheme is employed with respect to the transmission of a signal (e.g., digitally encoded data) from a transmitter (TX) 586 to a receiver (RX) 5-118 via a communication channel 590 (e.g., a transmission medium). In at least one embodiment, the receiver 5-118 and transmitter 586 may each include the hybrid LT logic 104 as described herein. According to embodiments, the receiver 5-118 and transmitter 586 may be capable of performing the method 400. The communication channel 590 can be PCIe, NVLink, Ethernet, InfiniBand, GRS, C2C, D2D, or the like. In this example, the transmitter 586 receives an input data 5-110 (i.e., the input data at time n is represented as “a(n)”), which is modulated in accordance with a modulation scheme (e.g., PAM4) and sends the signal 5-112 a(n) including a set of data symbols (e.g., symbols-3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, e.g., PAMn, where n is 2 to 16, or the like. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 590 may be a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 590 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 5-118 receives an incoming signal 5-114 over the channel 590. The receiver 5-118 can output a received signal 5-116, “v(n),” including the set of data symbols (e.g., symbols −3, −1, 1, 3, wherein the symbols represent coded binary data).

In at least one embodiment, the transmitter 586 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 5-118 can be part of a SerDes IC. The SerDes IC can include a clock-recovery circuit. The clock-recovery circuit can be coupled to an ADC and an equalization block. In another embodiment, the SerDes IC can include additional equalization block before a symbol detector. In at least some embodiments, the SerDes IC may include some or all of the features of the hybrid LT logic 104 as described herein. The SerDes IC may be capable of performing the method 400 as described herein.

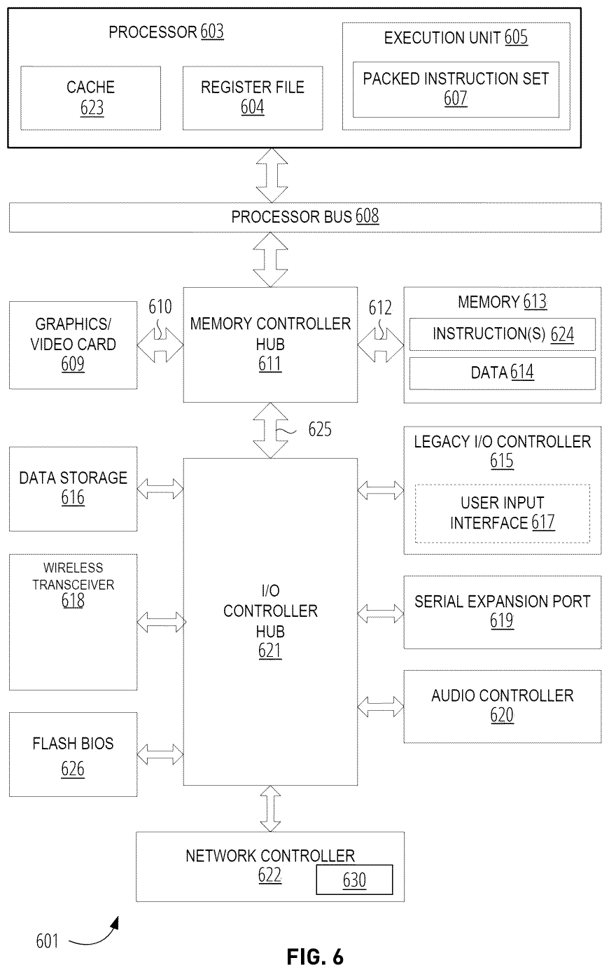

FIG. 6 illustrates an example computer system 601, including an error correction circuit 630, in accordance with at least some embodiments. In at least one embodiment, computer system 601 may be a system with interconnected devices and components, an SOC, or some combination. In at least one embodiment, computer system 601 is formed with a processor 603 that may include execution units to execute an instruction. In at least one embodiment, computer system 601 may include, without limitation, a component, such as a processor 603, to employ execution units including logic to perform algorithms for processing data. In at least one embodiment, computer system 601 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 601 may execute a version of WINDOWS′ operating system available from Microsoft Corporation of Redmond, Wash., although other operating systems (UNIX and Linux, for example), embedded software, and/or graphical user interfaces, may also be used.

In at least one embodiment, computer system 601 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 601 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 601 may include, without limitation, processor 603 that may include, without limitation, one or more execution units 605 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 601 is a single processor desktop or server system. In at least one embodiment, computer system 601 may be a multiprocessor system. In at least one embodiment, processor 603 may include, without limitation, a CISC microprocessor, a RISC microprocessor, a VLIW microprocessor, and a processor implementing a combination of instruction sets, or any other processor device, such as a digital signal processor, for example. In at least one embodiment, processor 603 may be coupled to a processor bus 608 that may transmit data signals between processor 603 and other components in computer system 601.

In at least one embodiment, processor 603 may include, without limitation, a Level 1 (“L1”) internal cache memory (“cache”) 623. In at least one embodiment, processor 603 may have a single internal cache or multiple levels of internal cache. In at least one embodiment, cache memory may reside externally to processor 603. In at least one embodiment, processor 603 may also include a combination of both internal and external caches. In at least one embodiment, a register file 604 may store different types of data in various registers including, without limitation, integer registers, floating point registers, status registers, and instruction pointer register.

In at least one embodiment, execution unit 605, including, without limitation, logic to perform integer and floating point operations, also resides in processor 603. Processor 603 may also include a microcode (“ucode”) read only memory (“ROM”) that stores microcode for certain macro instructions. In at least one embodiment, execution unit 605 may include logic to handle a packed instruction set 607. In at least one embodiment, by including packed instruction set 607 in an instruction set of a general-purpose processor 603, along with associated circuitry to execute instructions, operations used by many multimedia applications may be performed using packed data in a general-purpose processor 603. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 606 may also be used in microcontrollers, embedded processors, graphics devices, DSPs, and other types of logic circuits. In at least one embodiment, computer system 601 may include, without limitation, a memory 613. In at least one embodiment, memory 613 may be implemented as a DRAM device, an SRAM device, flash memory device, or other memory devices. Memory 613 may store instruction(s) 624 and/or data 614 represented by data signals that may be executed by processor 603.

In at least one embodiment, a system logic chip may be coupled to a processor bus 608 and memory 613. In at least one embodiment, the system logic chip may include, without limitation, a memory controller hub (“MCH”) 611, and processor 603 may communicate with MCH 611 via processor bus 608. In at least one embodiment, MCH 611 may provide a high bandwidth memory path 612 to memory 613 for instruction and data storage and for storage of graphics commands, data, and textures. In at least one embodiment, MCH 611 may direct data signals between processor 603, memory 613, and other components in computer system 601 and may bridge data signals between processor bus 608, memory 613, and a system I/O 625. In at least one embodiment, a system logic chip may provide a graphics port for coupling to a graphics controller. In at least one embodiment, MCH 611 may be coupled to memory 613 through high bandwidth memory path 612, and graphics/video card 609 may be coupled to MCH 611 through an Accelerated Graphics Port (“AGP”) interconnect 610.

In at least one embodiment, computer system 601 may use system I/O 625 that is a proprietary hub interface bus to couple MCH 611 to I/O controller hub (“ICH”) 621. In at least one embodiment, ICH 621 may provide direct connections to some I/O devices via a local I/O bus. In at least one embodiment, a local I/O bus may include, without limitation, a high-speed I/O bus for connecting peripherals to memory 613, a chipset, and processor 603. Examples may include, without limitation, an audio controller 620, a firmware hub (“flash BIOS”) 726, a wireless transceiver 618, a data storage 616, a legacy I/O controller 615 containing a user input interface 617, a keyboard interface, a serial expansion port 619, such as a USB, and a network controller 622. In at least one embodiment, the network controller 622 includes the error correction circuit 630. Data storage 616 may comprise a hard disk drive, a floppy disk drive, a CD-ROM device, a flash memory device, or other mass storage device.

In at least one embodiment, FIG. 6 illustrates a system, which includes interconnected hardware devices or “chips.” In at least one embodiment, FIG. 6 may illustrate an example SoC. In at least one embodiment, devices illustrated in FIG. 6 may be interconnected with proprietary interconnects, standardized interconnects (e.g., PCIe), or some combination thereof. In at least one embodiment, one or more components of system 602 are interconnected using compute express link (“CXL”) interconnects.

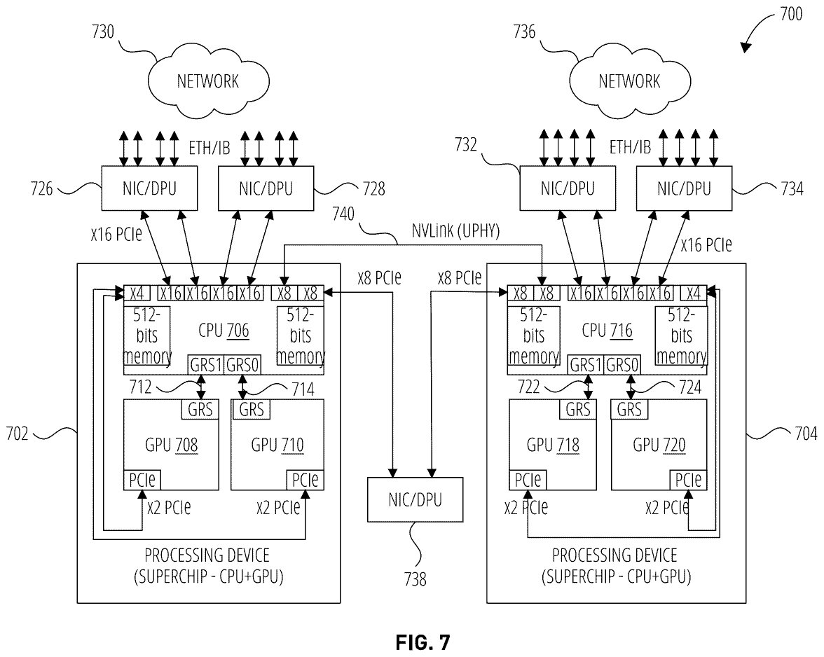

FIG. 7 is a block diagram of a computing system 700 having two processing devices coupled to each other and multiple networks according to at least one embodiment. The computing system 700 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 700. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 700 highly suitable for demanding applications that require significant processing power, such as artificial intelligence (AI), machine learning (ML), and data-intensive computing, while ensuring robust connectivity and scalability across various networked environments. The integrated circuits of the computing system 700 can include one or more CPUs and one or more GPUs. An example architecture of a multi-GPU architecture is illustrated in FIG. 7.

As illustrated in FIG. 7, the computing system 700 includes a processing device 702 with a multi-GPU architecture. In particular, the processing device 702 includes a CPU 706, a GPU 708, and a GPU 710. The CPU 706 can be coupled to the GPU 708 via an die-to-die (D2D) or chip-to-chip (C2C) interconnect 712, such as a Ground-Referenced Signaling interconnect (GRS interconnect). The CPU 706 can be coupled to the GPU 710 via a D2D or C2C interconnect 714. The CPU 706 can also be coupled to the GPU 708 and GPU 710 via PCIe interconnects. The CPU 706 can be coupled to one or more network interface cards (NICs) or data processing units (DPUs), which are coupled to one or more networks. For example, as illustrated in FIG. 7, the CPU 706 is coupled to a first NIC/DPU 726, which is coupled to a network 730. The CPU 706 is also coupled to a second NIC/DPU 728, which is coupled to the network 730. The NIC/DPU 726 and NIC/DPU 728 can be coupled to the network 730 over Ethernet (ETH) or InfiniBand (IB) connections.

The computing system 700 also includes a processing device 704 with a multi-GPU architecture. In particular, the processing device 704 includes a CPU 716, a GPU 718, and a GPU 720. The CPU 716 can be coupled to the GPU 718 via an D2D or C2C interconnect 722. The CPU 716 can be coupled to the GPU 720 via a D2D or C2C interconnect 724. The CPU 716 can also be coupled to the GPU 718 and GPU 720 via PCIe interconnects. The CPU 716 can be coupled to one or more NICs or DPUs, which are coupled to one or more networks. For example, as illustrated in FIG. 7, the CPU 716 is coupled to a first NIC/DPU 732, which is coupled to a network 736. The CPU 716 is also coupled to a second NIC/DPU 734, which is coupled to the network 736. The NIC/DPU 732 and NIC/DPU 734 can be coupled to the network 736 over Ethernet (ETH) or InfiniBand (IB) connections.

In at least one embodiment, the processing device 702 and the processing device 704 can communicate with each other via a NIC/DPU 738, such as over PCIe interconnects. The processing device 702 and processing device 704 can also communicate with each other over a high-bandwidth communication interconnects 740, such as an NVLink interconnect or other high-speed interconnects. The NIC/DPUs of FIG. 7 can be the various embodiments of the DPUs described herein.

In at least one embodiment, the computing system 700 is used for high-speed network communication and includes a processing unit (e.g., CPU 706, GPU 708, GPU 710, CPU 716, GPU 718, GPU 720, NIC/DPU 726, NIC/DPU 728, NIC/DPU 732, NIC/DPU 734, or NIC/DPU 738), and a network interface coupled to the processing unit. The network interface can include the operations and functionality of the DPUs described herein.

In at least one embodiment, the computing system 700 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

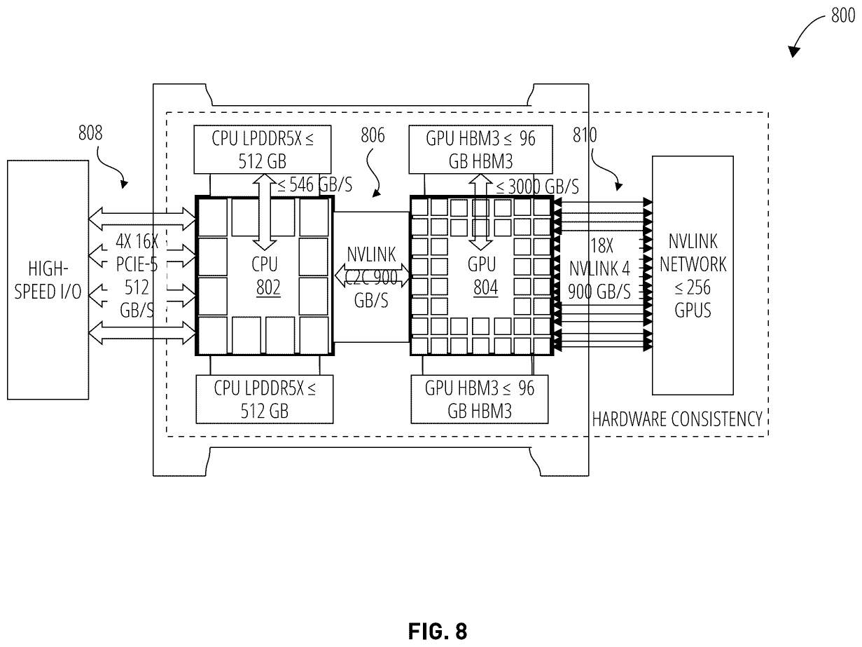

FIG. 8 is a block diagram of a computing system 800 having a CPU 802 and a GPU 804 in a single integrated circuit according to at least one embodiment. The computing system 800 can be a highly integrated design where a CPU 802 and GPU 804 are connected on a single integrated circuit, utilizing an NVLink C2C (Chip-to-Chip) interconnect 806 to enable fast, low-latency communication between the two processing units. This close integration allows for efficient data transfer and parallel processing between the CPU 802 and GPU 804, optimizing performance for complex computational tasks. The GPU elements within the computing system 800 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 810. Additionally, the computing system 800 can be designed to interface with a high-speed I/O through PCIe interconnects 808, ensuring rapid data transfer to and from external devices, further enhancing the system's capabilities in handling data-intensive tasks and providing robust connectivity to peripheral components. It should be noted that the C2C interconnects 806 can be considered D2D interconnects since the CPU 802 and the GPU 804 are located on the same integrated circuit. The integrated circuit can include CPU memory (also referred to as main memory) and GPU memory, which are accessible by the CPU 802 and the GPU 804, respectively, over high-speed interconnects. The computing system 800 can bring together performance of the GPU 804 with the versatility of the CPU 802. The CPU 802 can be connected with a high-bandwidth and memory coherent C2C interconnects 806 in a single integrated circuit. The computing system 800 can support a link switch system.

In at least one embodiment, the computing system 800 is used for high-speed network communication and includes a processing unit, and a network interface coupled to the processing unit. The network interface can include the operations and functionality of the DPUs described herein.

In at least one embodiment, the computing system 800 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

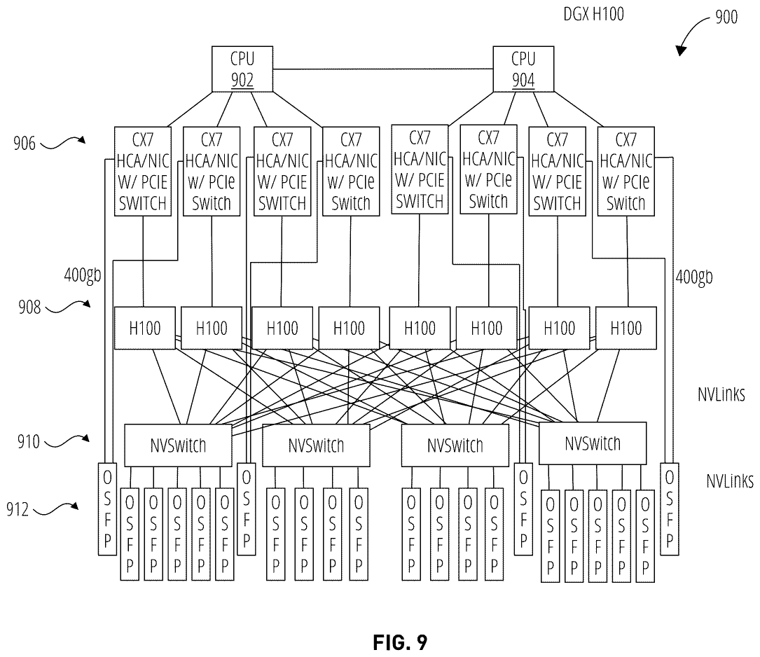

FIG. 9 is a block diagram of a computing system 900 having tensor core GPUs 908 according to at least one embodiment. The computing system 900 can be a DGX H100 system, which is a high-performance computing platform designed to meet the demands of AI, ML, and deep learning (DL) workloads. The computing system 900 can include multiple tensor core GPUs 908 (e.g., NVIDIA H100 Tensor Core GPUs). The tensor core GPUs 908 can be optimized for AI/ML/DL applications, offering exceptional performance for deep learning training, inference, and high-performance computing tasks. The tensor core GPUs 908 within the computing system 900 are interconnected using high-speed communication interfaces like NVLinks, enabling rapid data transfer between them, which is crucial for handling large-scale AI models and datasets with low latency. This computing system 900 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 908, the computing system 900 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 908 for their specific applications. The computing system 900 is ideally suited for large-scale AI model training, real-time inference, scientific simulations, data analytics, and other compute-intensive tasks that require massive parallel processing power.

The tensor core GPUs 908 can be coupled to multiple CPUs, such as CPU 902 and CPU 904, using switches 906 (e.g., CX7 HCA/NIC with PCIe switch). The tensor core GPUs 908 can be coupled to each other via switches 910 (e.g., NVSwitches). The switches 906 and switches 910 can be coupled to high-speed transceiver modules 912. The high-speed transceiver modules 912 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 900 remains capable of meeting increasing data demands and can be upgraded to support future advancements in network speeds, thus contributing to the system's overall performance and scalability.

In at least one embodiment, the computing system 900 can be considered a data-network configuration with full-bandwidth intra-server NVLinks. In this example, all eight tensor core GPUs 908 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 908 can half-subscribe eighteen NVLinks to GPUs in other servers. Four tensor core GPUs 908 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 908 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 900 is used for high-speed network communication and includes a processing unit (e.g., CPU 902, CPU 904, switches 906, tensor core GPUs 908, switches 910, high-speed transceiver modules 912), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 900 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media and one or more individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still CO-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A first device comprising:
an interface to couple to a physical link;
one or more processors; and
memory storing instructions that, upon being executed by the one or more processors, cause the first device to:
transmit, during a first time period of a link training (LT) operation, a first message to a second device connected to the first device via the interface, the first message comprising an indication of a second time period of the LT operation during which an uninterrupted training pattern is to be transmitted, the second time period being longer than the first time period; and
transmit, during the second time period of the LT operation, a second message to the second device via the interface, the second message comprising the uninterrupted training pattern used to perform training to achieve a first minimum bit error ratio (BER) performance for transmissions from the first device to the second device.

2. The first device of claim 1, wherein only the second message is transmitted to the second device during the second time period, and wherein the second message does not comprise a header.

3. The first device of claim 1, wherein the instructions further cause the first device to:
receive one or more third messages during the second time period of the LT operation; and
perform training to achieve a second minimum BER performance for transmissions from the second device to the first device.

4. The first device of claim 1, wherein the instructions further cause the first device to:
transmit, during the first time period after transmitting the first message, a third message to the second device via the interface, the third message comprising a proposed duration of the second time period.

5. The first device of claim 1, wherein the instructions further cause the first device to:
receive a third message during the first time period of the LT operation, the third message comprising an indication of a third time period; and
based on the second time period being greater than the third time period, selecting the second time period.

6. The first device of claim 5, wherein a length of the second message is determined based on selecting the second time period.

7. The first device of claim 1, wherein the uninterrupted training pattern comprises more than 16,384 symbols, and wherein the second time period comprises a same number of unit intervals (UI) as a number of symbols of the uninterrupted training pattern.

8. A method comprising:
transmitting, by a first device, a first message to a second device during a first time period of a link training (LT) operation, wherein the first message comprises an indication of a second time period of the LT operation during which an uninterrupted training pattern is to be transmitted, the second time period being longer than the first time period; and
transmitting, by the first device, a second message to the second device during the second time period, wherein the second message comprises the uninterrupted training pattern used to perform training to achieve a first minimum bit error ratio (BER) performance for transmissions from the first device to the second device.

9. The method of claim 8, wherein only the second message is transmitted to the second device during the second time period, and wherein the second message does not comprise a header.

10. The method of claim 8, further comprising:
receiving, by the first device, one or more third messages during the second time period of the LT operation; and
performing training to achieve a second minimum BER performance for transmissions from the second device to the first device.

11. The method of claim 8, further comprising:
transmitting, by the first device, a third message to the second device during the first time period after transmitting the first message, wherein the third message comprises a proposed duration of the second time period.

12. The method of claim 8, further comprising:
receiving, by the first device, a third message during the first time period of the LT operation, the third message comprising an indication of a third time period; and
based on the second time period being greater than the third time period, selecting the second time period.

13. The method of claim 12, wherein a length of the second message is determined based on selecting the second time period.

14. The method of claim 8, wherein the uninterrupted training pattern comprises more than 16,384 symbols, and wherein the second time period comprises a same number of unit intervals (UI) as a number of symbols of the uninterrupted training pattern.

15. A method comprising:
determining, by a first device, a length of a second period of time with a second device coupled with the first device via a communication link, wherein the second period of time is longer than a first period of time;
alternating between the first period of time and the second period of time;
continuously transmitting a training signal without interruption during the second period of time to perform link training to obtain a first minimum bit error rate (BER) for transmission between first device and second device; and
transmitting standard link training frames during the first period of time.

16. The method of claim 15, wherein determining the length of the second period of time comprises:
determining, by the first device, a first proposed value for the second period of time;
receiving, at the first device, a second proposed value for the second period of time from the second device;
selecting the longer proposed value between the first proposed value and the second proposed value, as the length of the second period of time.

17. The method of claim 15, wherein the training signal comprises a pseudo-random binary sequence.

18. The method of claim 15, wherein the first device and the second device alternate between the first period of time and the second period of time based on predefined criteria to optimize performance of the communication link.

19. The method of claim 15, further comprising using reserved bits within a link training frame header to carry at least the length of the second period of time.

20. The method of claim 15, further comprising:
initiating, by the first device, the link training by configuring specific bits in a link training frame header to request the second device to stop standard link training header transmission; and
transmitting, by the first device, a receiver ready signal to the second device to indicate completion of the link training.
